(19) United States
(12) Patent Application Publication
(10) Pub. No.: US 2021/0078501 A1
(43) Pub. Date: Mar. 18, 2021

(54) TRUCK BED MOUNTED BICYCLE RACK

(71) Applicant: Jason LORENZO, Auburn, CA (US)

(72) Inventor: Jason LORENZO, Auburn, CA (US)

(21) Appl. No.: 17/084,393

(22) Filed: Oct. 29, 2020

Related U.S. Application Data
(63) Continuation-in-part of application No. 16/419,208, filed on May 22, 2019, now abandoned.

(51) Int. Cl. B60R 9/10; B60R 9/06

(52) U.S. Cl. CPC B60R 9/10; B60R 9/06

(57) ABSTRACT

A truck bed mounted bicycle rack is disclosed. An example embodiment includes: a truck bed mounted bicycle rack comprising: a cross bar; and a plurality of side wing mounting brackets, a side wing mounting bracket attached to each end of the cross bar, the plurality of side wing mounting brackets each including a T-shaped flange for mounting the side wing mounting brackets to rails of a truck cargo bed, the T-shaped flange including a vertical portion for removable attachment to an inside surface of the rails of the truck cargo bed.

### PRIORITY PATENT APPLICATION

This patent application is a continuation-in-part (CIP) patent application drawing priority from U.S. non-provisional patent application Ser. No. 16/419,208; filed May 22, 2019. This present non-provisional patent application draws priority from the referenced patent application. The entire disclosure of the referenced patent application is considered part of the disclosure of the present application and is hereby incorporated by reference herein in its entirety.

### TECHNICAL FIELD

The disclosed subject matter relates to the field of bicycle racks and, in particular, to truck bed mounted bicycle racks.

### COPYRIGHT

A portion of the disclosure of this patent document contains material that is subject to copyright protection. The copyright owner has no objection to the facsimile reproduction of the patent document or the patent disclosure, as it appears in the U.S. Patent and Trademark Office patent files or records, but otherwise reserves all copyright rights whatsoever. The following notice applies to the disclosure provided herein and to the drawings that form a part of this document: Copyright 2018-2020, Jason LORENZO; All Rights Reserved.

### BACKGROUND

Pickup trucks or trucks with an open rear cargo bed can be useful for transporting one or more bicycles. However, conventional bicycle rack systems often require a user to disassemble the bicycle to attach the bike to the rack. For example many conventional systems require the user to remove the front wheel of the bike. Other conventional bicycle rack systems use complicated hardware mechanisms attached to the trailer hitch of the vehicle or attached to the tailgate of the truck. These devices typically require extensive set-up time and eliminate the ability of the truck driver to effectively use the tailgate or tow hitch assembly of the truck. Thus, there is a need for an improved apparatus for supporting a bicycle in the cargo bed of a pickup truck.

### SUMMARY

A truck bed mounted bicycle rack is disclosed. In various example embodiments, a universal bicycle rack for the cargo bed of a pickup truck allows a user to load and unload a bicycle quickly and easily with no disassembly of the bike required. The truck bed mounted bicycle rack of an example embodiment also allows a user to mount and un-mount the rack quickly in the bed of the truck. As a result, the user spends less time getting ready to go ride and more time enjoying riding the bicycle.

In an example embodiment, the truck bed mounted bicycle rack comprises a cross bar to which side wing mounting brackets are connected on each end of the cross bar. The truck bed mounted bicycle rack of the example embodiment is configured to transversely mount to the rails of the cargo bed of a truck using one of several alternative configurations of truck bed rail mounting brackets. Once the truck bed mounted bicycle rack is removably mounted to the rails of the truck cargo bed, the truck bed mounted bicycle rack allows the user to place a bicycle on the cross bar of the bicycle rack with the junction point of the bicycle being in contact with the cross bar of the rack. The junction point of the bicycle corresponds to the point where the head tube, top tube, and down tube join at the top portion of the bicycle. The junction point of the bicycle can also correspond to the point where the front forks of the bicycle attach to the bicycle frame. In this configuration with the bike placed on the cross bar of the bicycle rack at the junction point of the bike, the bike thereby straddles and securely rests on the cross bar of the bicycle rack in transverse fashion without the need to remove the front wheel of the bike. As a result, the truck bed mounted bicycle rack of an example embodiment allows the user to load and unload the bicycle quickly and easily with no disassembly of the bike required. The truck bed mounted bicycle rack of an example embodiment also allows the user to mount and un-mount the rack quickly in the bed of the truck. Because the truck bed mounted bicycle rack of an example embodiment does not use or block the tailgate of the truck as some conventional bike racks do, the truck bed mounted bicycle rack of an example embodiment enables full use of the truck tailgate and tow hitch assembly. Some conventional bike rack designs use the tow hitch assembly of the truck or use a pad that hangs over the tailgate, which prevents the use of the tailgate and also produces a high probability of scratching or damaging the outside of the truck tailgate.

There is currently no bicycle rack that allows a user to simply set a bike on a rack in the cargo bed of a truck without first removing the front wheel of the bike or otherwise disassembling a portion of the bike or attaching a mounting bracket to the bike. The conventional bike racks require a user to remove the front wheel of the bike and mount the forks of the bike to the rack with the removed front wheel placed somewhere in the cargo bed or passenger cab of the truck. In an alternative example embodiment, the bicycle rack can be mounted to the floor of the cargo bed of the truck instead of being mounted to the rails of the truck bed. The various example embodiments are described in more detail below.

### BRIEF DESCRIPTION OF THE DRAWINGS

Embodiments are illustrated by way of example and not limitation in the figures of the accompanying drawings, in which:

FIG. 1 illustrates a perspective view of the truck bed mounted bicycle rack of an example embodiment;

FIG. 2 illustrates a front or rear view of a truck bed mounted bicycle rack of an example embodiment;

FIG. 3 illustrates a top view of a truck bed mounted bicycle rack of an example embodiment;

FIG. 4 illustrates the cross bar portion of the truck bed mounted bicycle rack of an example embodiment;

FIG. 5 illustrates the side wing mounting bracket portion of the truck bed mounted bicycle rack of an example embodiment;

FIGS. 6A through 6C illustrate various alternative configurations of the truck bed rail mounting brackets used for mounting the truck bed mounted bicycle rack of an example embodiment to the cargo bed rails of a truck;

FIGS. 7A through 7C illustrate various alternative configurations of the truck bed rail mounting brackets attached to the side wing mounting bracket of the truck bed mounted bicycle rack, which are used for mounting the truck bed mounted bicycle rack of an example embodiment to the cargo bed rails of a truck;

FIG. 8 illustrates a perspective view of the truck bed mounted bicycle rack of an example embodiment as attached to the cargo bed rails of a truck;

FIG. 9 illustrates a side view of the truck bed mounted bicycle rack of an example embodiment as attached to the cargo bed rails of a truck with a bicycle positioned on the cross bar portion of the truck bed mounted bicycle rack;

FIG. 10 illustrates a top view of the truck bed mounted bicycle rack of an example embodiment as attached to the cargo bed rails of a truck with two bicycles positioned on the cross bar portion of the truck bed mounted bicycle rack;

FIG. 11 illustrates a perspective view of the cross bar portion of the truck bed mounted bicycle rack with a bicycle transversely positioned on the cross bar at the junction point of the bicycle;

FIG. 12 illustrates a perspective view of the cross bar portion of the truck bed mounted bicycle rack with a cushioning element or cross bar cushion wrapped around or enveloping the cross bar;

FIG. 13 illustrates a front or rear view of a truck bed mounted bicycle rack of an alternative example embodiment;

FIGS. 14 and 15 illustrate the side wing mounting bracket portion of the truck bed mounted bicycle rack of an alternative example embodiment; and

FIGS. 16 through 18 illustrate perspective views of the truck bed mounted bicycle rack of an alternative example embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

In various example embodiments disclosed and illustrated herein, a truck bed mounted bicycle rack 100 is described. In an example embodiment, the truck bed mounted bicycle rack 100 comprises a cross bar 110 to which side wing mounting brackets 120 are connected on each end of the cross bar 110. The truck bed mounted bicycle rack 100 of the example embodiment is configured to transversely mount to the rails of the cargo bed of a truck using one of several alternative configurations of truck bed rail mounting brackets 210, 220, and 230. Additional details of various example embodiments are provided below and in the accompanying drawings.

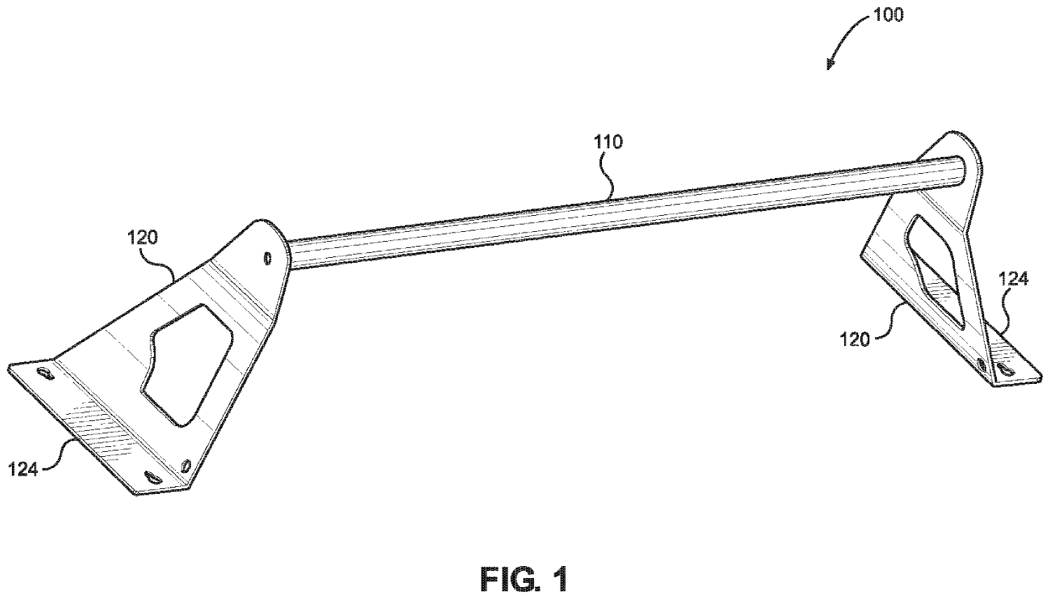

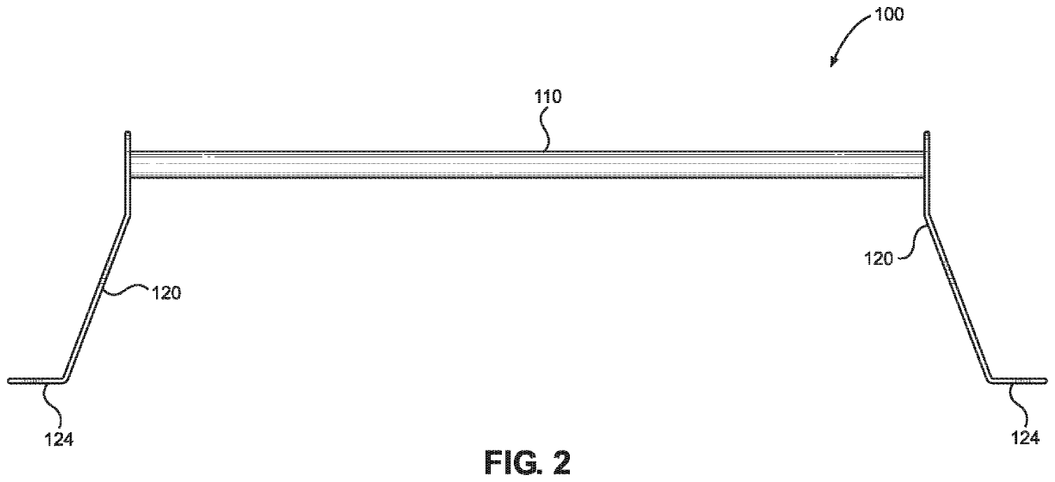

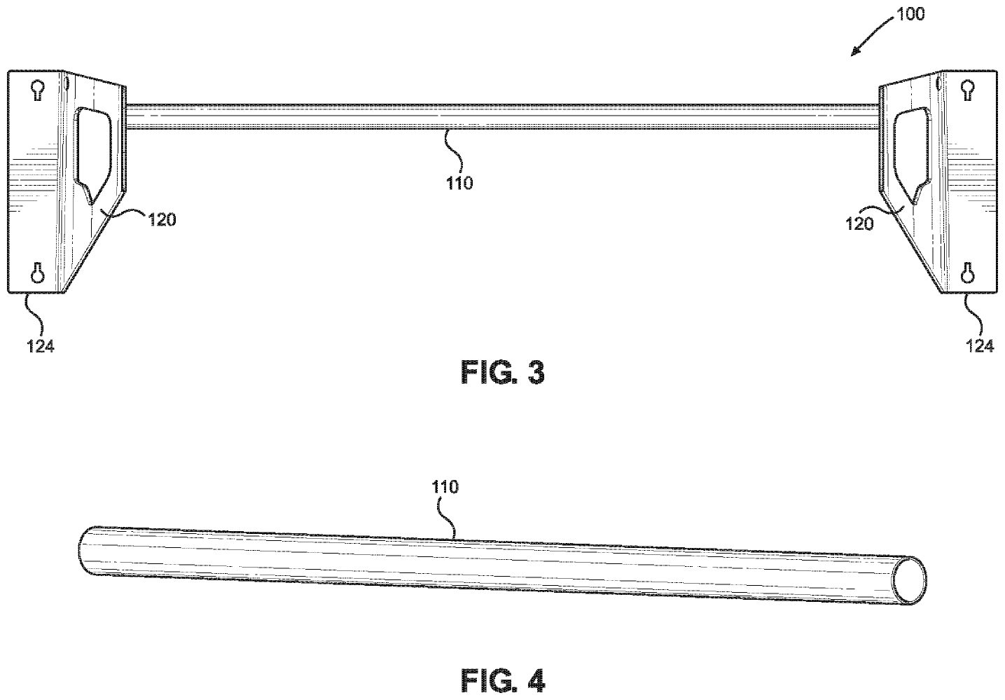

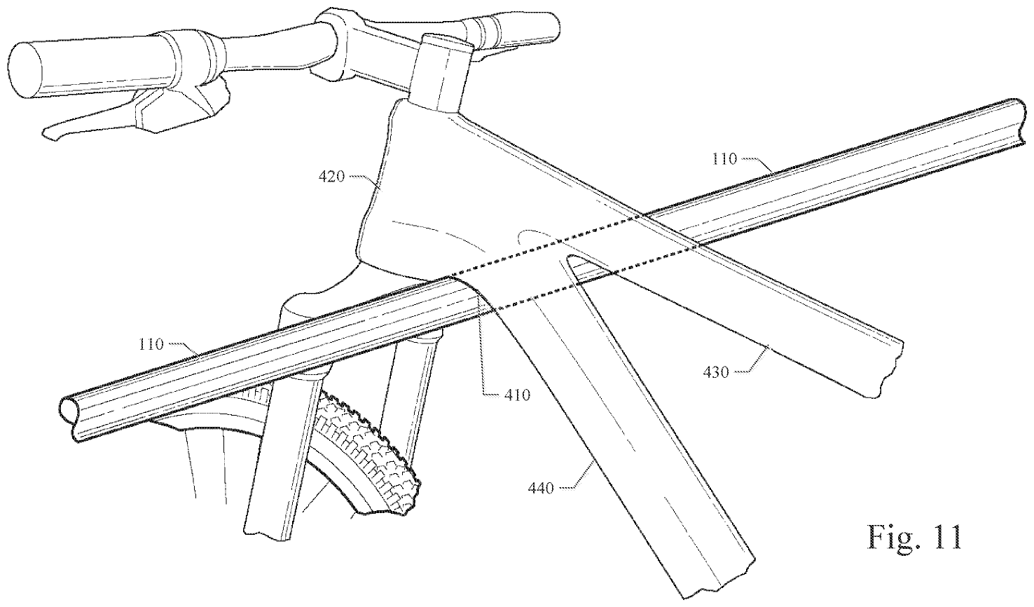

FIG. 1 illustrates a perspective view of the truck bed mounted bicycle rack 100 of an example embodiment. FIG. 2 illustrates a front or rear view of a truck bed mounted bicycle rack 100 of an example embodiment. FIG. 3 illustrates a top view of a truck bed mounted bicycle rack 100 of an example embodiment. FIG. 4 illustrates the cross bar 110 portion of the truck bed mounted bicycle rack 100 of an example embodiment. In the example embodiment, the truck bed mounted bicycle rack 100 shown in FIGS. 1 through 4 comprises a cross bar 110 to which side wing mounting brackets 120 can be connected on each end of the cross bar 110. The cross bar 110 and side wing mounting brackets 120 can be fabricated from any material strong enough to hold and support one or more bicycles, such materials including metal, steel, stainless steel, aluminum, plastics, composite materials, fiberglass, wood, hardened rubber, or combinations of the same. The purpose of the cross bar 110 is to allow one or more bicycles to rest on and be supported by the cross bar 110 in a variety of different ways, such as on the bicycle head tube, down tube, or forks. In an example embodiment, the truck bed mounted bicycle rack 100 allows the user to place a bicycle on the cross bar 110 of the bicycle rack 100 with the junction point 410 (see FIG. 11) of the bicycle being in contact with the cross bar 110 of the rack 100. The junction point 410 of the bicycle corresponds to the point where the head tube, top tube, and down tube join at the top portion of the bicycle. The junction point 410 of the bicycle can also correspond to the point where the front forks of the bicycle attach to the bicycle frame. In this configuration with the bike placed on the cross bar 110 of the bicycle rack 100 at the junction point 410 of the bike, the bike thereby straddles and securely rests on the cross bar 110 of the bicycle rack 100 in transverse fashion without the need to remove the front wheel of the bike. Additionally, the bicycle rack 100 allows the front wheel of the bike to have free range and to be pointed in any direction at any angle.

In various alternative embodiments, the cross bar 110 can be fabricated as a cylindrical tube or a solid rod with a diameter of one half inch up to 12 inches. In other alternative embodiments, the cross bar 110 can be fabricated in a variety of crosscut shapes, such as round, square, rectangular, triangular, hexagonal, oval, or the like. The cross bar 110 can be fixedly attached to the side wing mounting bracket 120 at each end of the cross bar 110 with welds, rivets, adhesives, machining, or the like. Alternatively, the cross bar 110 can be removably attached to the side wing mounting bracket 120 at each end of the cross bar 110 with nuts and bolts, screws, slide mounts, or the like. In another embodiment, the cross bar 110 can be fabricated with a telescoping expansion joint, which can be used to lengthen or shorten the lateral dimension of the cross bar 110 to accommodate truck cargo beds of varying sizes.

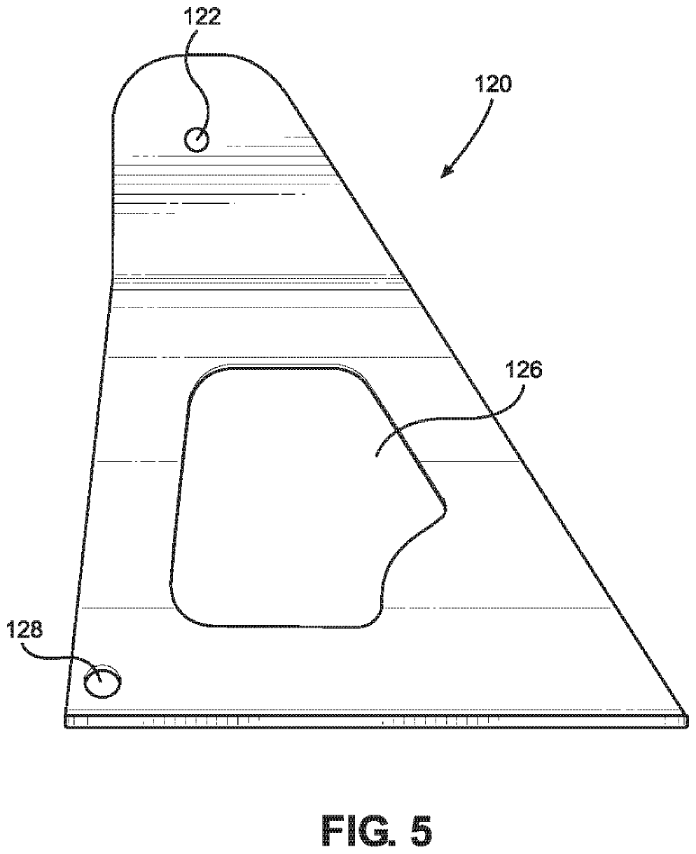

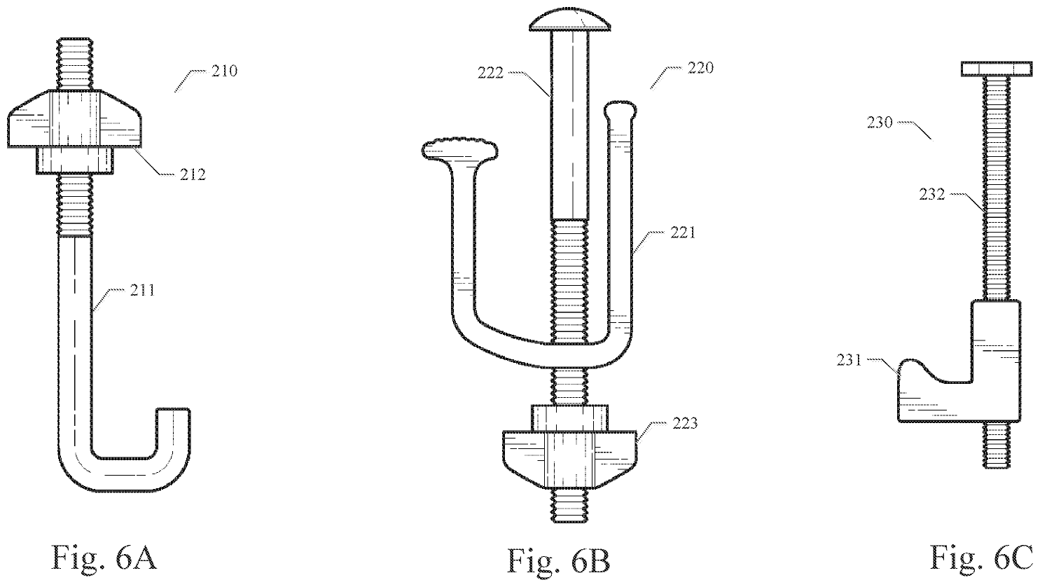

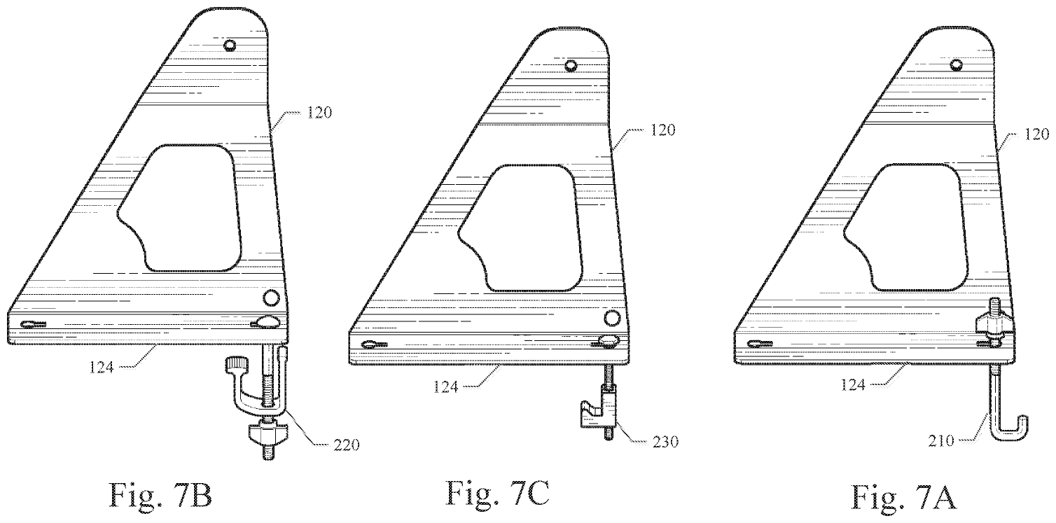

Referring to FIG. 5, an example embodiment illustrates the side wing mounting bracket 120 portion of the truck bed mounted bicycle rack 100. In various example embodiments, the side wing mounting bracket 120 can be fabricated as a wing-shaped plate with bends to provide strength for the rack 100. A hole 122 can be provided in the side wing mounting bracket 120 for connecting the cross bar 110 to the side wing mounting bracket 120 as described above. The side wing mounting bracket 120 can include a flange 124 (see FIGS. 1 through 3) to connect the side wing mounting bracket 120 to the bed rails of a truck with holes provided in the flange 124. The side wing mounting bracket 120 can be perforated with additional holes 126 to reduce the overall weight of the rack 100 while still maintaining strength. The side wing mounting bracket 120 can be perforated with another hole 128 to enable a lock or chain to securely connect the bicycles on the rack 100 to the side wing mounting bracket 120. The wing-shaped portion of the side wing mounting bracket 120 provides the appearance of a streamlined, sporty, and sleek bicycle rack. The side wing mounting bracket 120 can be removably attached to the cargo bed rails of a truck via flanges 124 in a variety of ways described in more detail in connection with FIGS. 6A, 6B, 6C, 7A, 7B, and 7C described in detail below.

The truck bed mounted bicycle rack 100 of the example embodiment is configured to transversely mount to the rails of the cargo bed of a truck using one of several alternative configurations of truck bed rail mounting brackets 210, 220, and 230 as shown in FIGS. 6A, 6B, 6C, 7A, 7B, and 7C. FIGS. 6A through 6C illustrate various alternative configurations of the truck bed rail mounting brackets 210, 220, and 230 used for mounting the truck bed mounted bicycle rack 100 of an example embodiment to the cargo bed rails 310 of a truck. FIGS. 7A through 7C illustrate various alternative configurations of the truck bed rail mounting brackets 210, 220, and 230 attached to the side wing mounting bracket 120 of the truck bed mounted bicycle rack 100, which are used for mounting the truck bed mounted bicycle rack 100 of an example embodiment to the cargo bed rails 310 of a truck.

Referring now to FIGS. 6A and 7A, a truck bed rail mounting bracket first alternative configuration 210 is shown. The truck bed rail mounting bracket first alternative configuration 210 includes a large J-shaped hook bolt 211 and a knob 212. The J-shaped hook bolt 211 is configured to capture the underside of the truck bed rail 310 and penetrate a hole in the flange 124 of the side wing mounting bracket 120. The knob 212, threaded on the bolt 211, can be used to tighten the side wing mounting bracket 120, and thus the rack 100, to the truck bed rail 310.

Referring now to FIGS. 6B and 7B, a truck bed rail mounting bracket second alternative configuration 220 is shown. The truck bed rail mounting bracket second alternative configuration 220 includes a U-shaped portion 221, threaded on a carriage bolt 222, and a knob 223 also threaded on the carriage bolt 222. The U-shaped portion 221 is configured to capture the underside of the truck bed rail 310. The carriage bolt 222 is configured to penetrate a hole in the flange 124 of the side wing mounting bracket 120. The knob 223, threaded on the carriage bolt 222, can be used to tighten the side wing mounting bracket 120, and thus the rack 100, to the truck bed rail 310.

Referring now to FIGS. 6C and 7C, a truck bed rail mounting bracket third alternative configuration 230 is shown. The truck bed rail mounting bracket third alternative configuration 230 includes a J-shaped portion 231 threaded on a hex bolt 232. The J-shaped portion 231 is configured to capture the underside of the truck bed rail 310. The hex bolt 232 is configured to penetrate a hole in the flange 124 of the side wing mounting bracket 120. The hex bolt 232 can be used to tighten the J-shaped portion 231 to the underside of the truck bed rail 310, thereby removably attaching the side wing mounting bracket 120, and thus the rack 100, to the truck bed rail 310.

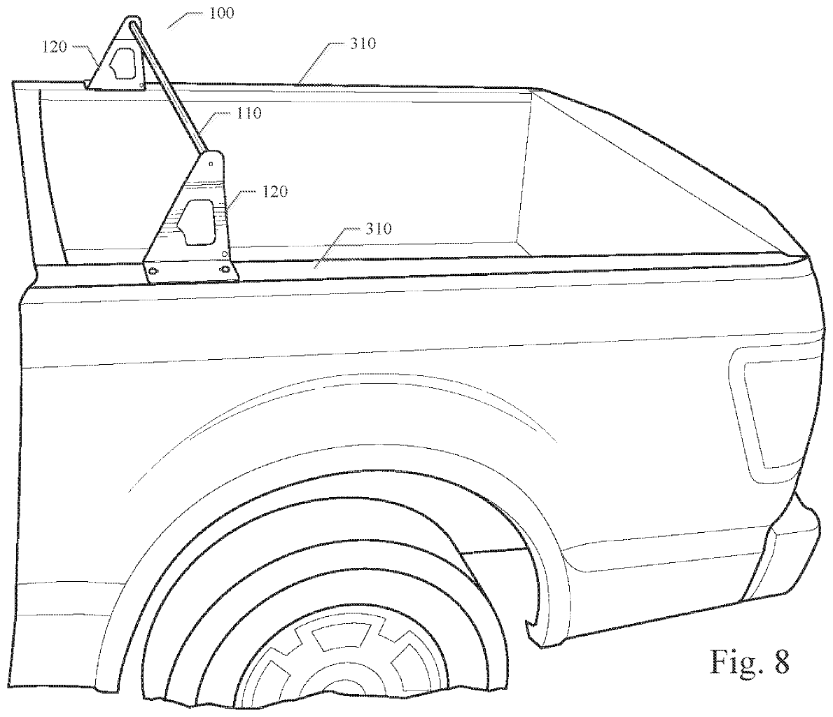

FIG. 8 illustrates a perspective view of the truck bed mounted bicycle rack 100 of an example embodiment as attached to the cargo bed rails 310 of a truck. Any of the truck bed rail mounting bracket configurations as described above can be used for the installation. The truck bed mounted bicycle rack 100 is thereby removably installed in the cargo bed of the truck without interfering or blocking the tailgate or tow hitch assembly of the truck. The truck bed mounted bicycle rack 100 can be installed at any desired position in the truck bed.

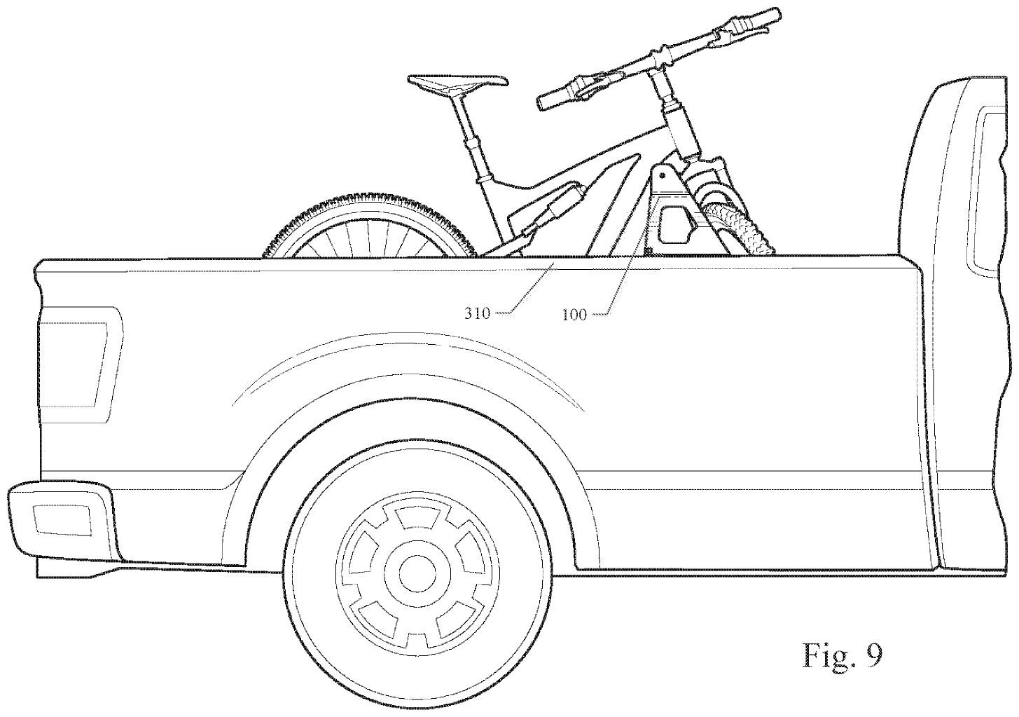

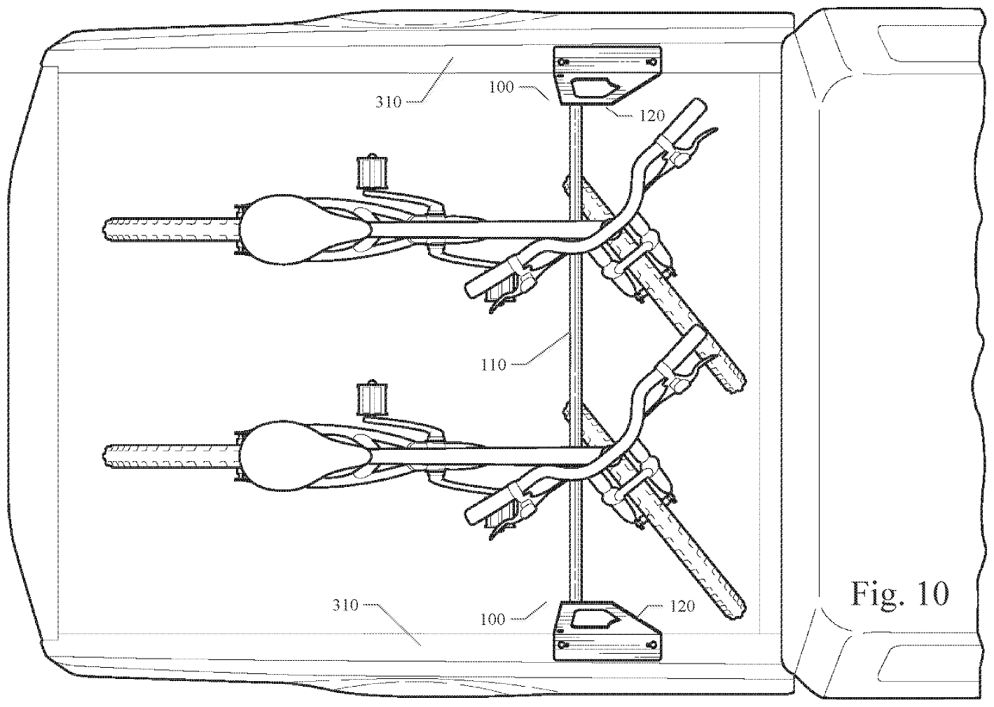

FIG. 9 illustrates a side view of the truck bed mounted bicycle rack 100 of an example embodiment as attached to the cargo bed rails 310 of a truck with a bicycle positioned on the cross bar 110 portion of the truck bed mounted bicycle rack 100.

FIG. 10 illustrates a top view of the truck bed mounted bicycle rack 100 of an example embodiment as attached to the cargo bed rails 310 of a truck via side wing mounting brackets 120 with two bicycles positioned on the cross bar 110 portion of the truck bed mounted bicycle rack 110.

FIG. 11 illustrates a perspective view of the cross bar 110 portion of the truck bed mounted bicycle rack 100 with a bicycle transversely positioned on the cross bar 110 at the junction point of the bicycle 410. Once the truck bed mounted bicycle rack 100 is removably mounted to the rails 310 of the truck cargo bed, the truck bed mounted bicycle rack 100 allows the user to place a bicycle on the cross bar 110 of the bicycle rack 100 with the junction point 410 of the bicycle being in contact with the cross bar 110 of the rack as shown in FIG. 11. The junction point 410 of the bicycle corresponds to the point where the head tube 420, top tube 430, and down tube 440 join at the top portion of the bicycle. The junction point 410 of the bicycle can also correspond to the point where the front forks of the bicycle attach to the bicycle frame. In this configuration with the bike placed on the cross bar 110 of the bicycle rack 100 at the junction point 410 of the bike, the bike thereby straddles and securely rests on the cross bar 110 of the bicycle rack 100 in transverse fashion without the need to remove the front wheel of the bike. As a result, the truck bed mounted bicycle rack 100 of an example embodiment allows the user to load and unload the bicycle quickly and easily with no disassembly of the bike required. The truck bed mounted bicycle rack 100 of an example embodiment also allows the user to mount and un-mount the rack 100 quickly in the bed of the truck. In an alternative example embodiment, the bicycle rack 100 can be mounted to the floor of the cargo bed of the truck instead of being mounted to the rails 310 of the truck bed.

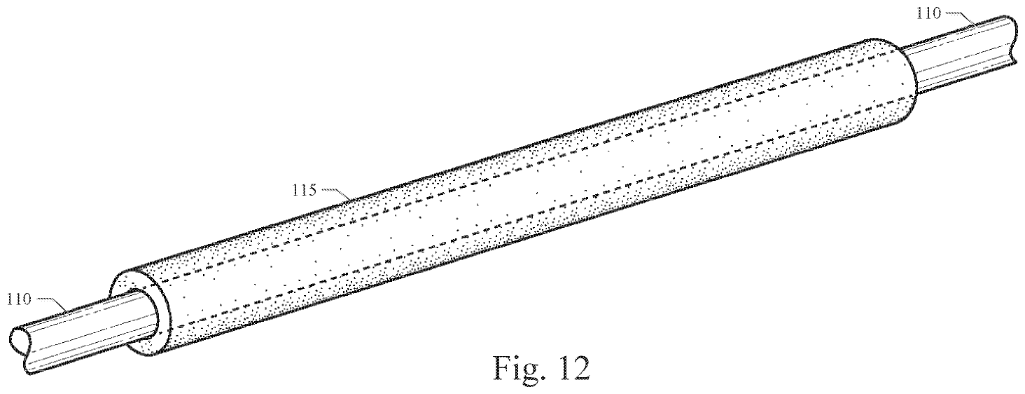

FIG. 12 illustrates a perspective view of the cross bar 110 portion of the truck bed mounted bicycle rack 100 with a cushioning element or cross bar cushion 115 wrapped around or enveloping the cross bar 110. The cross bar cushion 115 is provided in an example embodiment to cushion and protect the surfaces of the bicycle from damage as the bicycle rests on the cross bar 110. In various example embodiments, the cross bar cushion 115 can be fabricated from standard foam materials, plastic, rubber, cloth, or other soft and pliable materials. The cross bar cushion 115 can be fabricated with a lateral slit or cut to enable the cross bar cushion 115 to be removable from the cross bar 110.

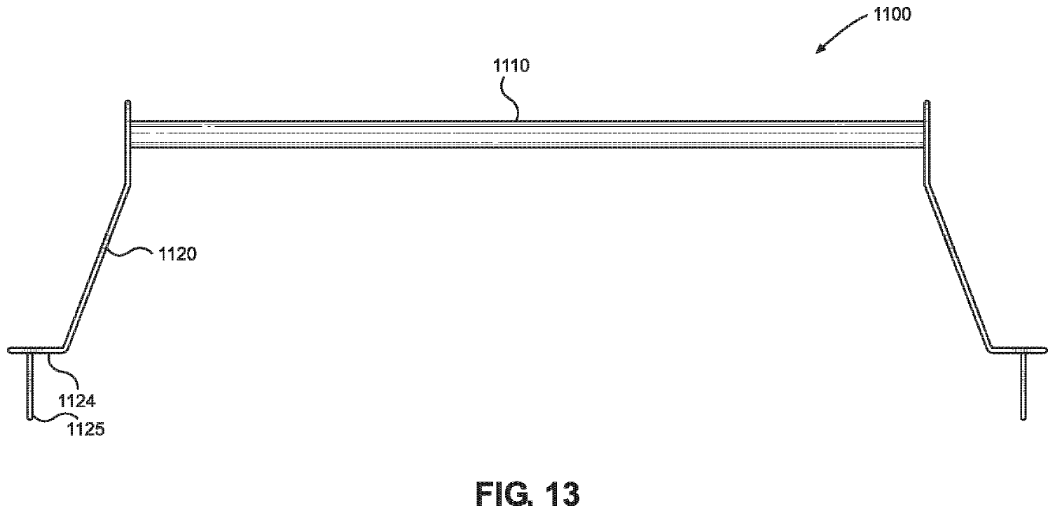

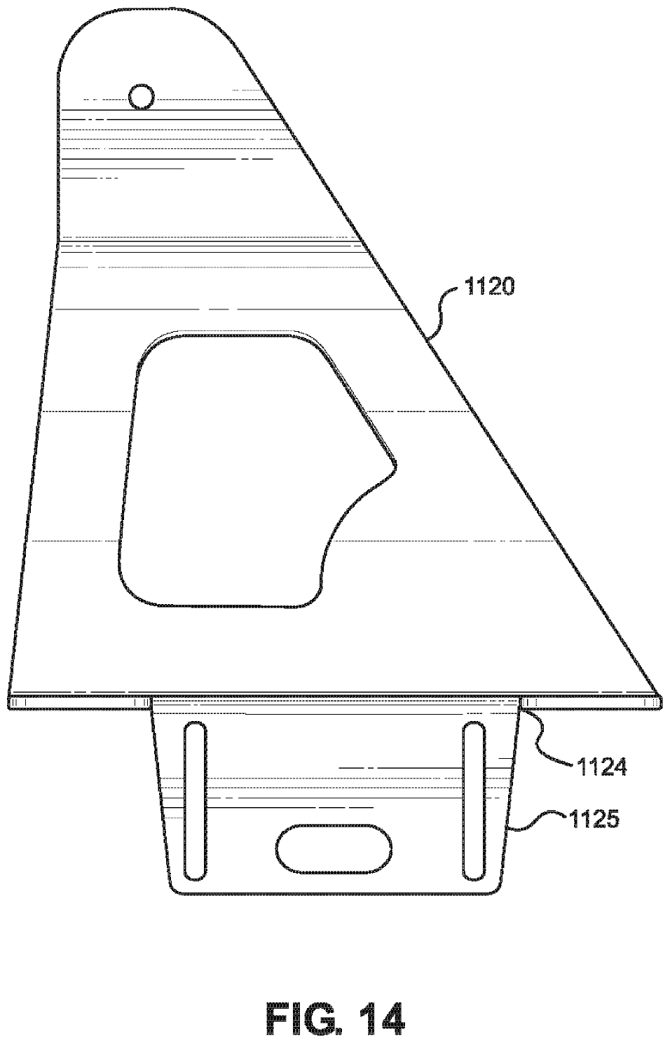

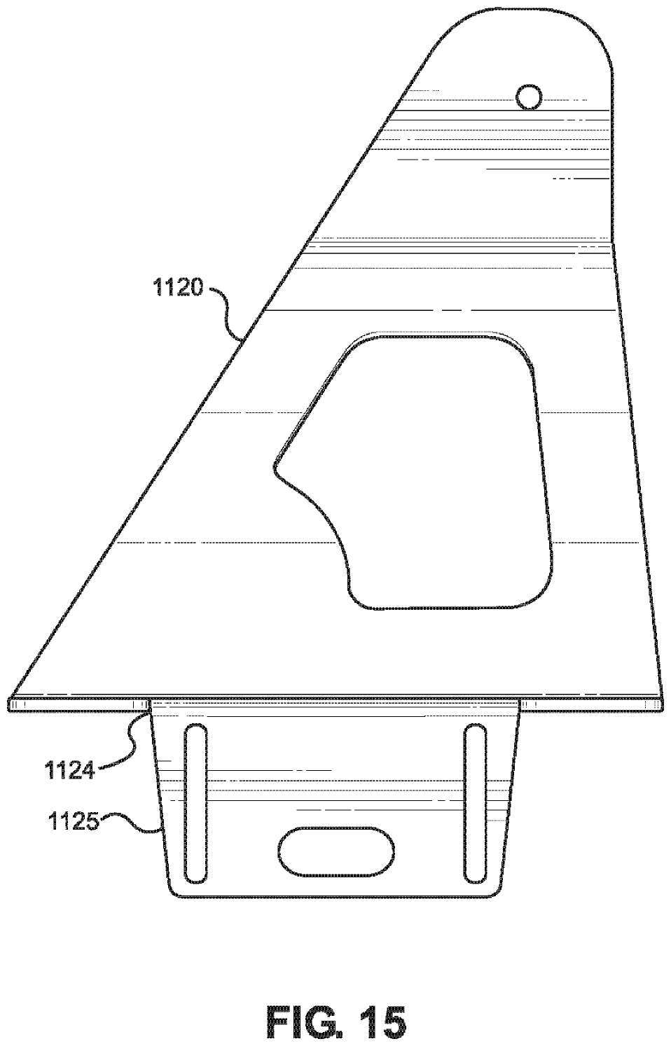

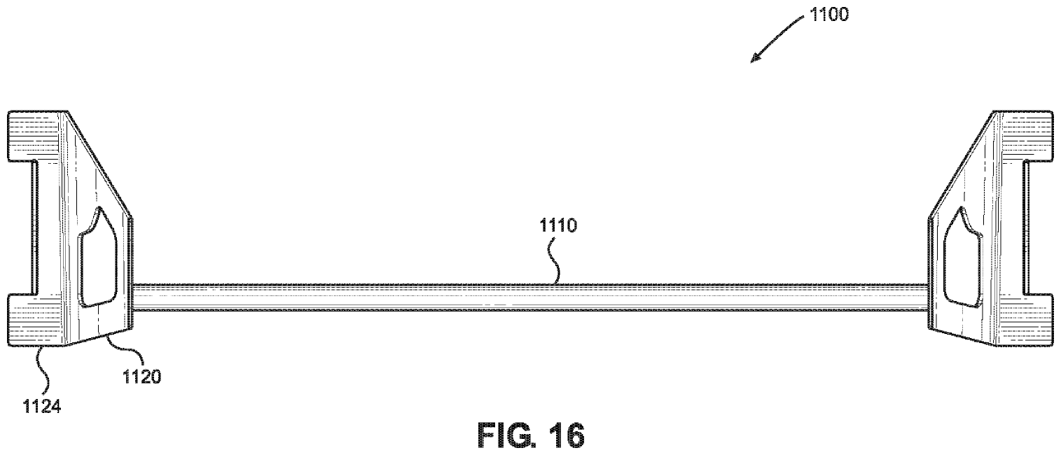

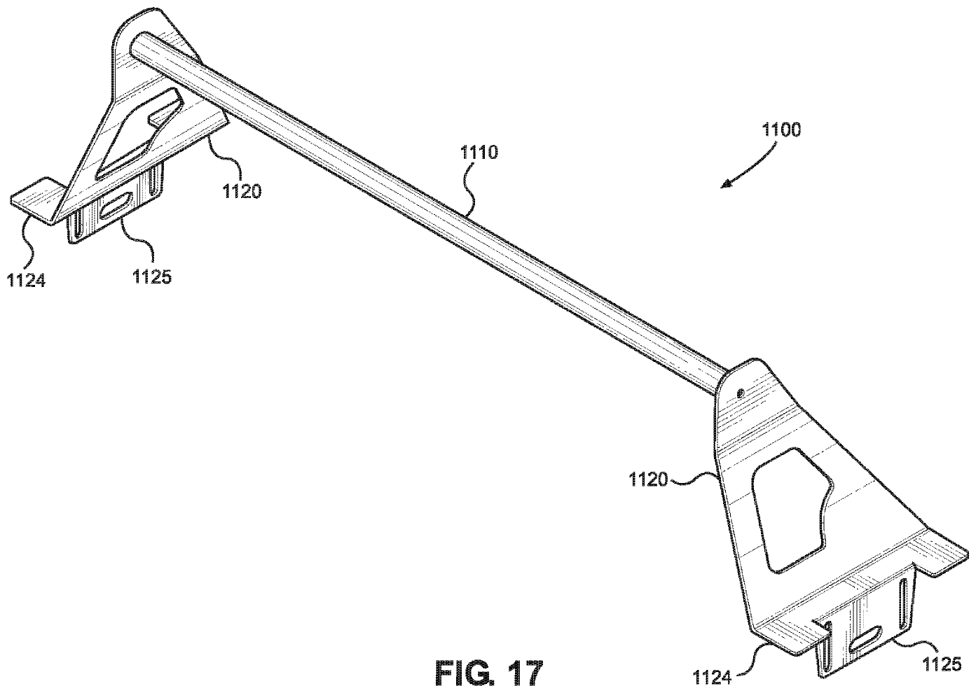

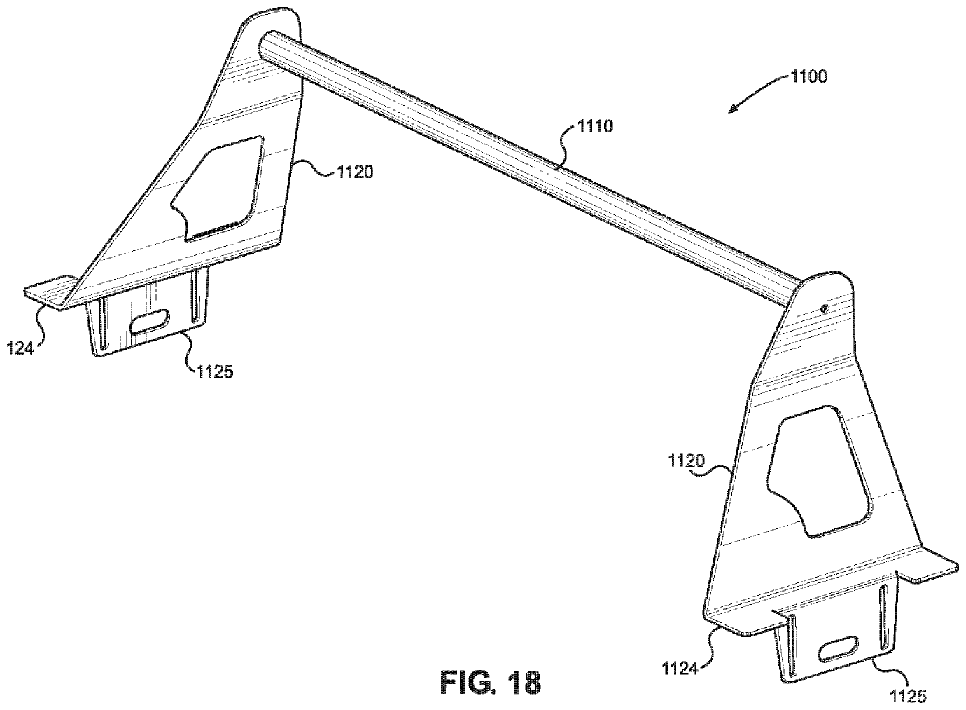

Referring to FIGS. 13 through 18, an alternative example embodiment 1100 is illustrated, the alternative embodiment 1100 including the side wing mounting bracket 1120 portion of the truck bed mounted bicycle rack 1100. In various example embodiments, the side wing mounting bracket 1120 can be fabricated as a wing-shaped plate with bends to provide strength for the rack 1100. A hole can be provided in the side wing mounting bracket 1120 for connecting the cross bar 1110 to the side wing mounting bracket 1120 as described above. The side wing mounting bracket 1120 can include a T-shaped flange 1124 (see detailed FIGS. 14 and 15) to connect the side wing mounting bracket 1120 to the bed rails of a truck with holes provided in the T-shaped flange 1124. The T-shaped flange 1124 of the alternative example embodiment 1100 provides a vertical portion 1125 with holes to allow the rack to be bolted to the inside of the truck bed rail and to provide a much firmer mounting option. The alternative embodiment 1100 eliminates a possible problem wherein the rack might slightly move from side to side.

The side wing mounting bracket 1120 can be perforated with additional holes to reduce the overall weight of the rack 1100 while still maintaining strength. The side wing mounting bracket 1120 can be perforated with holes to enable a lock or chain to securely connect the bicycles on the rack 1100 to the side wing mounting bracket 1120. The wing-shaped portion of the side wing mounting bracket 1120 provides the appearance of a streamlined, sporty, and sleek bicycle rack. The side wing mounting bracket 1120 can be removably attached to the inside surface of the cargo bed rails of a truck via flanges 1124 and vertical portion 1125.

Thus, a truck bed mounted bicycle rack is disclosed. Because the truck bed mounted bicycle rack of an example embodiment does not use or block the tailgate of the truck as some conventional bike racks do, the truck bed mounted bicycle rack of an example embodiment enables full use of the truck tailgate and tow hitch assembly. There is currently no bicycle rack that allows a user to simply set a bike on a rack in the cargo bed of a truck without first removing the front wheel of the bike or otherwise disassembling a portion of the bike or attaching a mounting bracket to the bike. The conventional bike racks require a user to remove the front wheel of the bike and mount the forks of the bike to the rack with the removed front wheel placed somewhere in the cargo bed or passenger cab of the truck. In an alternative example embodiment, the bicycle rack can be mounted to the floor of the cargo bed of the truck instead of being mounted to the rails of the truck bed.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used only for descriptive purposes and not to be construed as limiting. The elements, materials, geometries, dimensions, and sequence of operations may all be varied for particular applications. Parts of some embodiments may be included in, or substituted for, those of other embodiments. While the foregoing examples of dimensions and ranges are considered typical, the various embodiments are not limited to such dimensions or ranges.

The Abstract is provided to allow the reader to quickly ascertain the nature and gist of the technical disclosure. The Abstract is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, a truck bed mounted bicycle rack is disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A truck bed mounted bicycle rack comprising:
a cross bar; and
a plurality of side wing mounting brackets, a side wing mounting bracket attached to each end of the cross bar, the plurality of side wing mounting brackets each including a T-shaped flange for mounting the side wing mounting brackets to rails of a truck cargo bed, the T-shaped flange including a vertical portion for removable attachment to an inside surface of the rails of the truck cargo bed.

2. The truck bed mounted bicycle rack of claim 1 wherein the vertical portion of the T-shaped flange including holes for bolting the T-shaped flange to the inside surface of the rails of the truck cargo bed.

3. The truck bed mounted bicycle rack of claim 1 wherein the cross bar and plurality of side wing mounting brackets are fabricated from a material from the group consisting of: metal, steel, stainless steel, aluminum, plastics, composite materials, fiberglass, wood, hardened rubber, and combinations of the same.

4. The truck bed mounted bicycle rack of claim 1 wherein the plurality of side wing mounting brackets include wing-shaped plates with bends to provide strength.

5. The truck bed mounted bicycle rack of claim 1 wherein the cross bar is configured to enable a user to place a bicycle on the cross bar at a junction point of the bicycle, the bicycle thereby straddling and securely resting on the cross bar in transverse fashion without a need to remove a front wheel of the bicycle.

6. The truck bed mounted bicycle rack of claim 1 wherein the cross bar is fabricated in a crosscut shape from the group consisting of: round, square, rectangular, triangular, hexagonal, and oval.

7. The truck bed mounted bicycle rack of claim 1 wherein the cross bar includes a cross bar cushion.
